(19) United States
(12) Patent Application Publication
(10) Pub. No.: US 2021/0373766 A1
(43) Pub. Date: Dec. 2, 2021

(54) METHOD FACILITATING DATA TRANSMISSION, APPARATUS, AND STORAGE MEDIUM THEREOF

(71) Applicant: HON HAI PRECISION INDUSTRY CO., LTD., New Taipei (TW)

(72) Inventor: DA-CHENG SUNG, New Taipei (TW)

(21) Appl. No.: 17/018,489

(22) Filed: Sep. 11, 2020

(30) Foreign Application Priority Data
Jun. 1, 2020 (CN) 202010486232.8

(51) Int. Cl. G06F 3/06; G06F 9/48

(52) U.S. Cl. CPC G06F 3/064; G06F 3/0659; G06F 9/4812; G06F 3/0604; G06F 3/0673; G06F 3/0653

(57) ABSTRACT

A method for transmitting data between a processor and a storage medium includes receiving data from the processor and acquiring identifier information of the data. The storage medium queries a start address based on the identifier information. A specified storage block corresponding to the data is set as a target storage block, and a target control module is set based on the specified data operation. The target control module with a pointer pointing at the start address transmits the data sections of the data. When an interrupt command is received and the pointed-to address is an end address, an output function of the storage medium is disabled to maintain integrity of the data while transmitting. An apparatus and a storage medium applying the method are also disclosed.

### FIELD

The subject matter herein generally relates to data transmission.

### BACKGROUND

Electronic devices usually include a central processing unit (CPU), a storage medium, such as a dynamic random access memory (DRAM) and a static random access memory (SRAM). Data generated in different processes is temporarily stored in the storage medium and is processed for providing to a function module. The CPU needs to read the target data from the storage medium and analyze the target data to determine a transmitting order. The above operations take a lot of time, and a response time of CPU during data transmission is slow.

Thus, there is room for improvement in the art.

### BRIEF DESCRIPTION OF THE FIGURES

Implementations of the present disclosure will now be described, by way of example only, with reference to the attached figures.

FIG. 1 is a flowchart illustrating an embodiment of method for transmitting data.

FIG. 2 is a detailed flowchart illustrating the block 11 of the method of FIG. 1.

FIG. 3 is a detailed flowchart illustrating the block 12 of the method of FIG. 1.

FIG. 4 is a diagram illustrating an embodiment of an apparatus for transmitting data.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

The present disclosure provides a method for transmitting data.

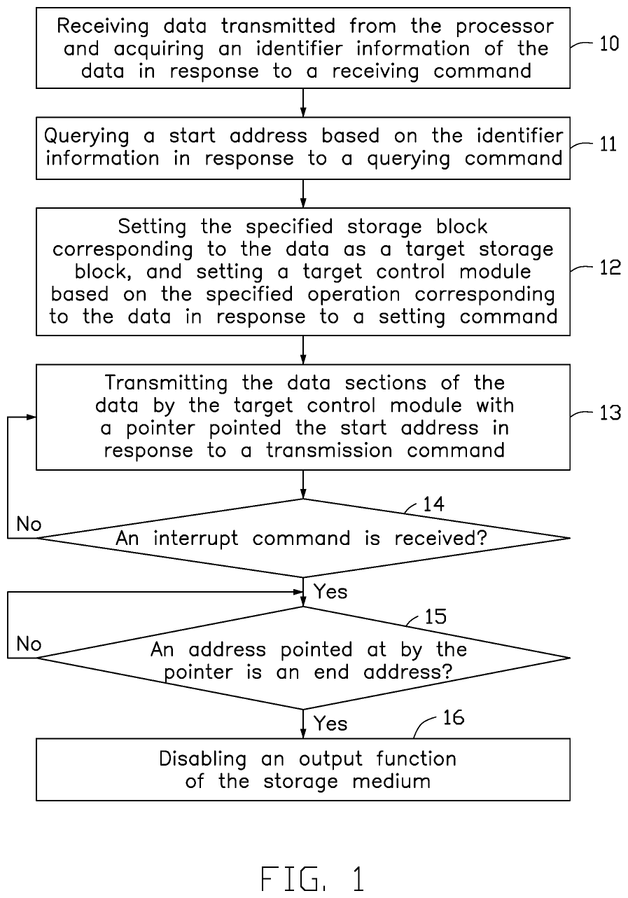

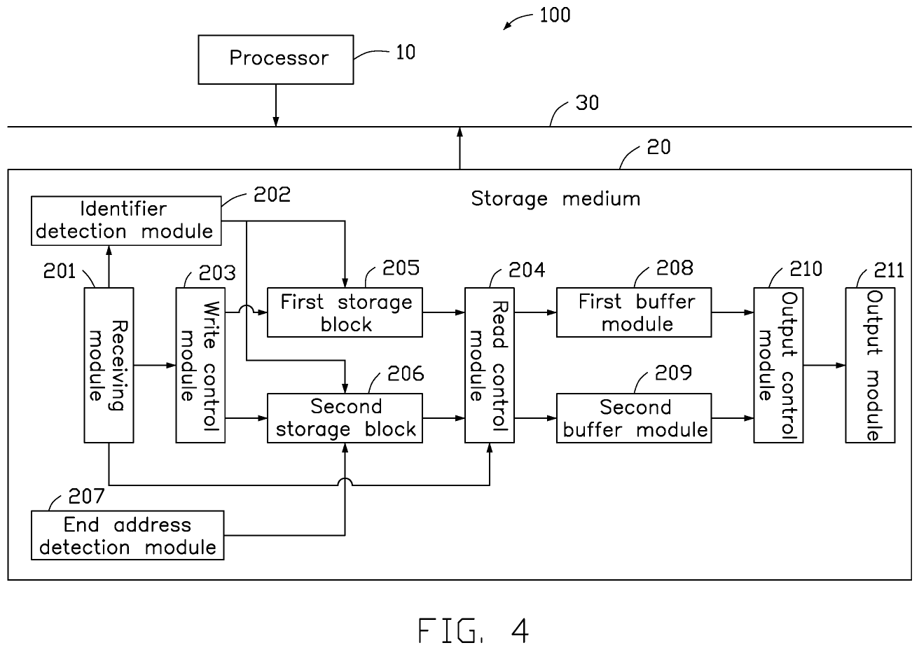

FIG. 1 shows a flowchart of a method for the above. The method is used in a data transmitting system. The data transmitting system includes at least one processor 10 (as shown in FIG. 4) and at least one storage medium 20 (as shown in FIG. 4). The data transmitting system provides a visible interface for establishing a communication between users and the data being transmitted. The method is used for transmitting data from the processor 10 and executing an interrupt test.

The processor 10 can be a micro-processor, or a digital processor. The processor 10 is used for running the program codes stored in the storage medium 20 to execute different functions. The modules in FIG. 4 are program codes stored in the storage medium 20 and are implemented by the processor 10 for executing the method. The processor 10 can be a central processing unit (CPU), or a large scale integrated circuit, being an operating core and a control core.

The storage medium 20 stores program codes. The storage medium 20 can be an embedded circuit having a storing function, such as memory card, trans-flash card, smart media card, secure digital card, and flash card, and so on. The processor 10 communicates with the storage medium 20 through a data bus 30.

The storage medium 20 stores an operation system, an internet communication interface, and a data transmitting program. The operation system manages and controls hardware and programs of a data transmitting apparatus 100. The operation system further supports operations of other software and programs. The internet communication interface establishes communications between the members in the storage medium 20, and communications between the hardware and the software in the data transmitting apparatus 100. The storage medium 20 includes a first storage block 205 (as shown in FIG. 4) and a second storage 206 (as shown in FIG. 4).

FIG. 1 shows a flowchart of the method for transmitting data.

In block 10, in response to a receiving command, the storage medium 20 receives data transmitted from the processor 10 and acquires an identifier information of the data.

In one embodiment, the data includes several data sections, a specified storage block, a specified operation information, and an identifier. The specified storage block and the specified operation information can be set by users. In one embodiment, the identifier information can be 0×2. “0” represents a first storage block 205 as the specified storage block, and “2” represents a read operation as the specified operation information. The identifier information identifies a specified start address in the specified storage block. The identifier information is a positive integer. In one embodiment, the identifier information can be a default identifier or a specified identifier. The default identifier corresponds to a default start address, and the specified identifier corresponds to a specified start address. In one embodiment, the default identifier is 0, and the specified identifier can be 1, 2, or 3. Both the first storage block 205 and the second storage block 206 can include a table with a relationship between the default identifier, the specified identifier, a default start address, and a specified start address.

In block 11, in response to a querying command, the storage medium 10 queries a start address based on the identifier information.

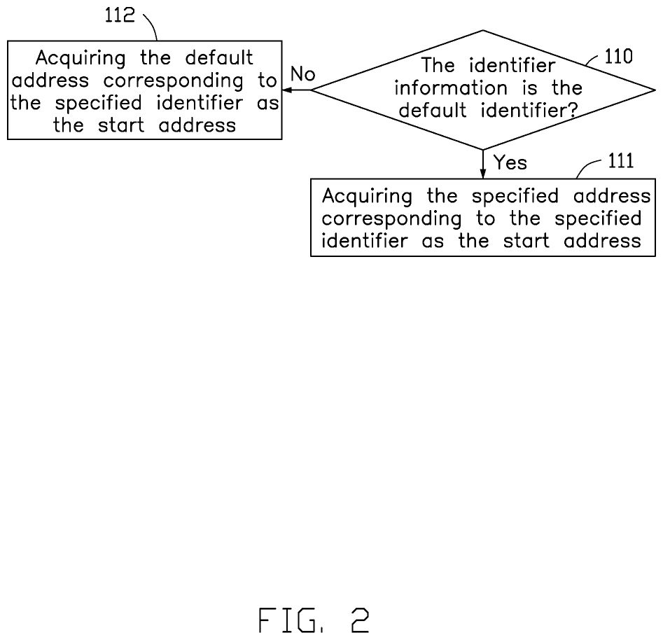

FIG. 2 shows a detailed flowchart of the block 11. The block of the storage medium 10 querying a start address based on the identifier information, further comprises:

In block 110, whether the identifier information is determined as the default identifier;

In block 111, the specified address corresponding to the specified identifier is acquired as the start address when the identifier information is determined as the specified identifier.

In block 112, the default address corresponding to the default identifier are acquired as the start address when the identifier information is determined as the default identifier.

In one embodiment, the default address corresponding to the default identifier is 468, and the specified address corresponding to the specified identifier is 476.

In block 12, in response to a setting command, the specified storage block corresponding to the data is set as a target storage block, and a target control module is set based on the specified operation in the received data.

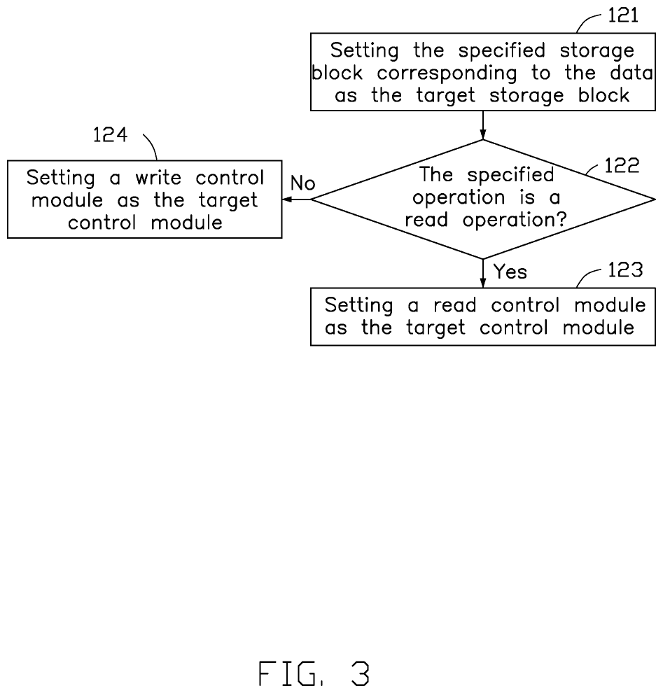

FIG. 3 shows a detailed flowchart of the block 12. In one embodiment, the block of in response to a setting command, the specified storage block corresponding to the data being set as a target storage block, and a target control module being set based on the specified operation in the received data further comprises:

In block 121, the specified storage block corresponding to the data is set as the target storage block.

In block 122, determining whether the specified operation is a read operation.

In block 123, a read control module is set as the target control module when the specified operation is the read operation.

In block 124, a write control module is set as the target control module when the specified operation is the write operation.

In block 13, in response to a transmission command, the target control module with a pointer pointing at the start address transmits the data sections of the data.

In one embodiment, the storage medium 20 further includes a first buffer module 208 (as shown in FIG. 4) and a second buffer module 209 (as shown in FIG. 4). When the specified operation is the read operation, the data section of the data from the start address is transmitted to the first buffer module by the transmission operation. When the specified operation is the write operation, the data section of the data from the processor 10 is stored in the target storage module from the start address by the transmission operation.

In block 14, determining whether an interrupt command is received in response to a determining command.

In block 15, determining whether an address being pointed at by the pointer is an end address when the interrupt command is received.

In block 16, an output function of the storage medium 20 is disabled when the address pointed at by the pointer is the end address.

When no interrupt command is received, the procedure returns to block 13.

In one embodiment, until an interrupt command is received, the target control module continues transmitting the data section corresponding to an initial address, when the data section of the data corresponding to the end address is transmitted.

In one embodiment, an output module 211 module (as shown in FIG. 4) in the storage medium 20 is disabled, for disabling the output function of the storage medium 20.

When the address being pointed at by the pointer is not the end address, the procedure returns to block 14.

In one embodiment, all commands can be inputted by the terminal device. The terminal device can include a keyboard and a touch screen, not being limited thereto. The commands can be inputted by operations on the visible interface. The operations can be sliding operations or click operations (such as a single click or double-click) on virtual keys in the visible interface. In detail, the keys can be mechanical keys or virtual keys (such as virtual icons), not limited thereto.

The above method facilitates a determination by the storage medium 20 as to a specified address and transmission operation based on the data or command, and computing load on the processor 10 is reduced while the transmitting the data. Processing speed of the processor 10 is improved, and when receiving the interrupt command, the end address of the storage medium is determined, so improving an integrity of the data.

FIG. 4 shows a data transmission apparatus 100. The data transmission apparatus 100 includes a processor 10, a storage medium 20, and a data bus 30.

The processor 10 can be a micro-processor, or a digital processor. The processor 10 is used for running the program codes stored in the storage medium 20 to execute different functions. The modules in FIG. 4 are program codes stored in the storage medium 20 and are implemented by the processor 10 for executing the method for transmitting data. The processor 10 can be a central processing unit (CPU), or a large scale integrated circuit, being an operating core and a control core.

The storage medium 20 stores program codes. The storage medium 20 can be an embedded circuit having a storing function, such as memory card, trans-flash card, smart media card, secure digital card, and flash card, and so on.

The storage medium 20 transmits data with the processor 10 through a data bus 30. The storage medium 20 stores an operation system, an internet communication interface, and a data transmitting program. The operation system manages and controls hardware and programs of a data transmitting apparatus 100. The operation system further supports operations of other software and programs. The internet communication interface establishes communications between the members in the storage medium 20, and communications between the hardware and the software in the data transmitting apparatus 100. The storage medium 20 includes a first storage block 205 and a second storage 206.

The storage medium 20 further includes:

A receiving module 201 receives data transmitted from the processor 10 and acquires an identifier information of the data in response to a receiving command.

In one embodiment, the data includes several data sections, a specified storage block, a specified operation information, and an identifier. The specified storage block and the specified operation information can be set by users. In one embodiment, the identifier information can be 0×2. “0” represents a first storage block as the specified storage block, and “2” represents a read operation as the specified operation information. The identifier information identifies a specified start address in the specified storage block. The identifier information is a positive integer. In one embodiment, the identifier information can be a default identifier or a specified identifier. The default identifier corresponds to a default start address, and the specified identifier corresponds to a specified start address. In one embodiment, the default identifier is 0, and the specified identifier can be 1, 2, or 3. Both the first storage block 205 and the second storage block 206 can include a table with a relationship between the default identifier, the specified identifier, a default start address, and a specified start address.

An identifier detection module 202 queries a start address based on the identifier information in response to a querying command.

In one embodiment, the identifier detection module 202 further determines whether the identifier information is determined as the default identifier. When the identifier information is determined as the specified identifier, the identifier detection module 202 further acquires the specified address corresponding to the specified identifier as the start address. When the identifier information is determined as the default identifier, the identifier detection module 202 further acquires the default address corresponding to the default identifier as the start address.

In one embodiment, the default address corresponding to the default identifier is 468, and the specified address corresponding to the specified identifier is 476.

The receiving module 201, in response to a setting command, further sets the specified storage block corresponding to the data as a target storage block and sets a target control module based on the specified operation corresponding to the data. In one embodiment, the receiving module 201 further determines whether the specified operation is a read operation. When the specified operation is the read operation, the receiving module 201 further sets a read control module as the target control module. When the specified operation is the write operation, the receiving module 201 further sets a write control module as the target control module.

The receiving module 201 further controls the target control module with a pointer pointing at the start address to transmit the data sections of the data in response to a transmission command.

In one embodiment, the storage medium 20 further includes a first buffer module 208 corresponding to the first storage block 205 and a second buffer module 209 corresponding to the second storage block 206. When the specified operation is the read operation, the data section of the data from the start address is transmitted to the first buffer module by the transmission operation. When the specified operation is the write operation, the data section of the data from the processor 10 is stored in the target storage module from the start address by the transmission operation. The first buffer module 208 and the second buffer module 209 can output the buffer data to an output module 211 through an output control module 210.

The receiving module 201, in response to a determining command, further determines whether an interrupt command is received.

An end address detection module 207 determines whether an address pointed at by the pointer is an end address when the interrupt command is received.

The end address detection module 207 further disables an output function of the storage medium 20 when the address pointed at by the pointer is the end address.

In one embodiment, the output module 211 is disabled based on the control of the output control module 210, where the end address detection module 207 for controlling the output function of the storage medium 20 is disabled.

In one embodiment, until an interrupt command is received, the target control module continues transmitting the data section corresponding to an initial address, after the data section of the data corresponding to the end address is transmitted.

Based on the above apparatus, the storage medium 20 determines a specified address and transmits accordingly based on the data or command, computing load of the processor 10 is reduced while the data is being transmitted, and a processing speed of the processor 10 is improved. On receiving the interrupt command, the end address of the storage medium is determined, so improving an integrity of the data.

A storage medium 20 is also provided. The storage medium 20 is a computer readable storage medium. The computer readable storage medium stores at least one command. The at least one command implemented by a processor 10 to perform the following steps:

In block 10, in response to a receiving command, the storage medium 20 receives data transmitted from the processor 10 and acquires an identifier information of the data.

In one embodiment, the data includes several data sections, a specified storage block, a specified operation information, and an identifier. The specified storage block and the specified operation information can be set by users. In one embodiment, the identifier information can be 0×2. “0” represents a first storage block as the specified storage block, and “2” represents a read operation as the specified operation information. The identifier information identifies a specified start address in the specified storage block. The identifier information is a positive integer. In one embodiment, the identifier information can be a default identifier or a specified identifier. The default identifier corresponds to a default start address, and the specified identifier corresponds to a specified start address. In one embodiment, the default identifier is 0, and the specified identifier can be 1, 2, or 3. Both the first storage block 205 and the second storage block 206 can include a table with a relationship between the default identifier, the specified identifier, a default start address, and a specified start address.

In block 11, in response to a querying command, the storage medium 10 queries a start address based on the identifier information.

FIG. 2 shows a detailed flowchart of the block 11. The block of the storage medium 10 querying a start address based on the identifier information further comprises:

In block 110, whether the identifier information is determined as the default identifier;

In block 111, the specified address corresponding to the specified identifier is acquired as the start address when the identifier information is determined as the specified identifier.

In block 112, the default address corresponding to the default identifier are acquired as the start address when the identifier information is determined as the default identifier.

In one embodiment, the default address corresponding to the default identifier is 468, and the specified address corresponding to the specified identifier is 476.

In block 12, in response to a setting command, the specified storage block corresponding to the data is set as a target storage block, and a target control module is set based on the specified operation in the received data.

FIG. 3 shows a detailed flowchart of the block 12. In one embodiment, in response to a setting command, the block of the specified storage block corresponding to the data being set as a target storage block, and a target control module being set based on the specified operation in the received data further comprises:

In block 121, the specified storage block corresponding to the data is set as a target storage block.

In block 122, determining whether the specified operation is a read operation.

In block 123, a read control module is set as the target control module when the specified operation is the read operation.

In block 124, a write control module is set as the target control module when the specified operation is the write operation.

In block 13, in response to a setting command, the target control module with a pointer pointed at the start address transmits the data sections of the data.

In one embodiment, the storage medium 20 further includes a first buffer module 208 (as shown in FIG. 4) and a second buffer module 209 (as shown in FIG. 4). When the specified operation is the read operation, the data section of the data from the start address is transmitted to the first buffer module by the transmission operation. When the specified operation is the write operation, the data section of the data from the processor 10 is stored in the target storage module from the start address by the transmission operation.

In block 14, determining whether an interrupt command is received in response to a determining command.

In block 15, determining whether an address being pointed at by the pointer is an end address when the interrupt command is received.

In block 16, an output function of the storage medium 20 is disabled when the address being pointed at by the pointer is the end address.

When no interrupt command is received, the procedure returns to block 13.

In one embodiment, until an interrupt command is received, the target control module continues transmitting the data section corresponding to an initial address, when the data section of the data corresponding to the end address is transmitted.

In one embodiment, an output module 211 module (as shown in FIG. 4) in the storage medium 20 is disabled, for disabling the output function of the storage medium 20.

When the address being pointed at by the pointer is not the end address, the procedure returns to block 14.

The above method facilitates a determination by the storage medium 20 as to a specified address and transmission operation based on the data or command, and computing load on the processor 10 is reduced while the transmitting the data. Processing speed of the processor 10 is improved, and when receiving the interrupt command, the end address of the storage medium is determined, so improving an integrity of the data.

While various and preferred embodiments have been described the disclosure is not limited thereto. On the contrary, various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A method for communication between a storage medium and a processor; the storage medium comprises a first storage block and a second storage block; the storage medium stores at least one command; the at least one command is implemented by the processor to execute the following steps:
receiving data from the processor and acquiring identifier information of the data in response to a receiving command; the data corresponds to one of the first storage block and the second storage block as a specified storage block;
querying a start address based on the identifier information in response to a querying command;
setting the specified storage block corresponding to the data as a target storage block, and setting a target control module based on the specified operation corresponding to the data in response to a setting command;
transmitting the data sections of the data by the target control module with a pointer pointed the start address in response to a transmission command;
determining whether an interrupt command is received;
determining whether an address pointed at by the pointer is an end address when the interrupt command is received; and
disabling an output function of the storage medium when the address pointed at by the pointer is the end address;
wherein the identifier identifies whether there is a specified start address in the target storage block.

2. The method of claim 1, wherein the identifier information comprises a default identifier and a specified identifier; the step of querying a start address based on the identifier information in response to a querying command comprises:
determining whether the identifier information is the default identifier;
acquiring a specified address corresponding to the specified identifier as the start address when the identifier information is the specified identifier; and
acquiring a default address corresponding to the default identifier as the start address when the identifier information is the default identifier.

3. The method of claim 2, wherein the default address corresponding to the default identifier is 468, and the specified address corresponding to the specified identifier is 476.

4. The method of claim 1, wherein the step of setting the specified storage block corresponding to the data as a target storage block, and setting a target control module based on the specified operation corresponding to the data in response to a setting command comprises:
setting the specified storage block corresponding to the data as the target storage block;
determining whether the specified operation is a read operation;
setting a read control module as the target control module when the specified operation is the read operation; and
setting a write control module as the target control module when the specified operation is the write operation.

5. The method of claim 1, wherein the method further comprises:
continuing transmitting the data sections of the data corresponding to an initial address after the data section of the data corresponding to the end address is transmitted when no interrupt command is received.

6. A data transmitting apparatus comprises a storage medium and at least one processor; the storage medium stores at least one command; the storage medium comprises a first storage block and a second storage block; the at least one commands is implemented by the at least one processor to execute functions; the storage medium comprising:
a receiving module, configured to receive data transmitted from the processor and acquire an identifier information of the data in response to a receiving command; the data corresponds to one of the first storage block and the second storage block as a specified storage block;
an identifier detection module, configured to query a start address based on the identifier information in response to a querying command; and
an end address detection module;
wherein the receiving module further sets the specified storage block corresponding to the data as a target storage block, and sets a target control module based on the specified operation corresponding to the data in response to a setting command; the receiving module further transmits the data sections of the data by the target control module with a pointer pointed the start address in response to a transmission command; the receiving module further determines whether an interrupt command is received; the end address detection module determines whether an address pointed at by the pointer is an end address when the interrupt command is received; when the address pointed at by the current pointer is the end address; the end address detection module further controls an output function of the storage medium to be disabled; the identifier identifies whether there is a specified start address in the target storage block.

7. The data transmitting apparatus of claim 6, wherein the identifier information comprises a default identifier and a specified identifier; the identifier detection module further determines whether the identifier information is the default identifier; when the identifier information is the specified identifier, the identifier detection module acquires a specified address corresponding to the specified identifier as the start address; when the identifier information is the default identifier, the identifier detection module acquires a default address corresponding to the default identifier as the start address.

8. The data transmitting apparatus of claim 7, wherein the default address corresponding to the default identifier is 468, and the specified address corresponding to the specified identifier is 476.

9. The data transmitting apparatus of claim 6, wherein the receiving module further determines whether the specified operation is a read operation; when the specified operation is the read operation, the receiving module sets a read control module as the target control module; when the specified operation is the write operation, the receiving module sets a write control module as the target control module.

10. The data transmitting apparatus of claim 6, wherein when no interrupt command is received, the target control module further continues transmitting the data sections of the data corresponding to an initial address after the data section of the data corresponding to the end address is transmitted.

11. A storage medium, the storage medium is a computer readable storage medium; the storage medium stores at least one command; the at least one command is implemented by a processor to execute the following steps:
receiving data from the processor and acquiring identifier information of the data in response to a receiving command;
querying a start address based on the identifier information;
setting the specified storage block corresponding to the data as a target storage block, and setting a target control module based on the specified operation corresponding to the data in response to a setting command;
transmitting the data sections of the data by the target control module with a pointer pointed the start address in response to a transmission command;
determining whether an interrupt command is received;
determining whether an address pointed at by of the pointer is an end address when the interrupt command is received; and
disabling an output function of the storage medium when the address pointed at by the pointer is the end address;
wherein the identifier identifies whether there is a specified start address in the target storage block.

12. The storage medium of claim 11, wherein the identifier information comprises a default identifier and a specified identifier; the step of querying a start address based on the identifier information in response to a querying command comprises:
determining whether the identifier information is the default identifier;
acquiring a specified address corresponding to the specified identifier as the start address when the identifier information is the specified identifier; and
acquiring a default address corresponding to the default identifier as the start address when the identifier information is the default identifier.

13. The storage medium of claim 12, wherein the default address corresponding to the default identifier is 468, and the specified address corresponding to the specified identifier is 476.

14. The storage medium of claim 11, wherein the step of setting the specified storage block corresponding to the data as a target storage block, and setting a target control module based on the specified operation corresponding to the data in response to a setting command comprises:
setting the specified storage block corresponding to the data as the target storage block;
determining whether the specified operation is a read operation;
setting a read control module as the target control module when the specified operation is the read operation; and
setting a write control module as the target control module when the specified operation is the write operation.

15. The storage medium of claim 11, wherein the method further comprises:
continuing transmitting the data sections of the data corresponding to an initial address after the data section of the data corresponding to the end address is transmitted when no interrupt command is received.
